(19) United States
(12) Patent Application Publication
(10) Pub. No.: US 2017/0191172 A1
(43) Pub. Date: Jul. 6, 2017

(54) ARTIFICIAL PHOTOSYNTHESIS MODULE

(71) Applicants: FUJIFILM Corporation, Tokyo (JP); Japan Technological Research Association of Artificial Photosynthetic Chemical Process, Tokyo (JP)

(72) Inventors: Hiroshi NAGATE, Kashiwa-shi (JP); Naotoshi SATO, Ashigara-kami-gun (JP)

(73) Assignees: FUJIFILM Corporation, Tokyo (JP); Japan Technological Research Association of Artificial Photosynthetic Chemical Process, Tokyo (JP)

(21) Appl. No.: 15/462,367

(22) Filed: Mar. 17, 2017

Related U.S. Application Data
(63) Continuation of application No. PCT/JP2015/073714, filed on Aug. 24, 2015.

(30) Foreign Application Priority Data
Sep. 29, 2014 (JP) 2014-198485

(51) Int. Cl. C25B 1/00; C25B 9/06; C25B 11/04; C25B 15/08; H01G 9/20; C25B 1/06; C25B 9/18

(52) U.S. Cl. CPC C25B 1/003; C25B 1/06; C25B 9/06; C25B 9/18; C25B 15/08; H01G 9/2013; H01G 9/2068; C25B 11/0405; C25B 11/0415; C25B 11/0473

(57) ABSTRACT

An artificial photosynthesis module is used for decomposition of an electrolytic aqueous solution into hydrogen and oxygen by light. The artificial photosynthesis module has an oxygen generation electrode having a first protrusion and a first recess alternately arranged thereon, and a hydrogen generation electrode having a second protrusion and a second recess alternately arranged thereon. The hydrogen generation electrode and the oxygen generation electrode are in contact with the electrolytic aqueous solution, and at least one electrode of the hydrogen generation electrode or the oxygen generation electrode includes a conductive layer and a photocatalyst layer provided on the conductive layer. The hydrogen generation electrode and the oxygen generation electrode are arranged side by side, the second protrusion of the oxygen generation electrode faces the first recess of the hydrogen generation electrode in an arrangement direction, and the first protrusion faces the second recess in the arrangement direction.

### CROSS-REFERENCE TO RELATED APPLICATIONS

This application is a Continuation of PCT International Application No. PCT/JP2015/073714 filed on Aug. 24, 2015, which claims priority under 35 U.S.C. §119(a) to Japanese Patent Application No. 2014-198485 filed on Sep. 29, 2014. The above application is hereby expressly incorporated by reference, in its entirety, into the present application.

### BACKGROUND OF THE INVENTION

1. Field of the Invention

The present invention relates to an artificial photosynthesis module that decomposes an electrolytic aqueous solution into hydrogen and oxygen by light, and particularly, to the artificial photosynthesis module having electrodes on which a recess and a protrusion are alternately formed.

2. Description of the Related Art

Hydrogen generating devices that electrolyzes water to generate hydrogen, with the electricity generated using fossil fuels, have been suggested in the past. Meanwhile, clean energy for not depending on fossil fuels and fossil resources is required from viewpoints of the current environmental destruction on a global basis, permanent energy problems, and the like.

Artificial photosynthesis has been learned from plant photosynthesis, and is attracting much attention as a method of obtaining energy and resources with inexhaustible solar light, water, and carbon dioxide gas, without depending on fossil resources. Devices that decomposes an electrolytic aqueous solution to generate oxygen and hydrogen has been suggested in the past as one of the forms using solar light energy that is renewable energy.

For example, JP4406689B describes an oxygen and hydrogen producing device in which water can be decomposed into hydrogen and oxygen only with radiation of light with application of external bias by adopting a structure in which a solution of a visible-light-responsive photocatalyst, such as a dye-sensitizing photocatalyst, and a redox medium are included in a hydrogen generation cell of multiple cells that are made conductive by a conducting wire or the like, a semiconductor thin film electrode is dipped in an electrolyte solution in one oxygen generation cell, and the conducting wire is simply connected to a counter electrode of a hydrogen generation chamber from the semiconductor thin film electrode.

Additionally, JP-2004-256378A describes a method for producing oxygen and hydrogen from water in which an electrode, which oxidizes a reductant of the redox medium to change the reductant into an oxidant of the redox medium, is installed in an aqueous solution of a photocatalysis tank including a photocatalyst and the oxidant of the redox medium, and the reductant of the generated redox medium is electrolyzed, oxidized and changed into the oxidant of the redox medium. An electrode that oxidizes the reductant of the redox medium to change the reductant into the oxidant of the redox medium includes a comb-type electrode.

A carbon dioxide reduction device of JP-2013-253269A includes a photoelectric conversion layer having a light-receiving surface and a back surface, an electrolytic solution tank, first and second electrolyzing electrodes provided with the electrolytic solution being interposed therebetween in the electrolytic solution tank, and a CO₂ supply unit that supplies carbon dioxide into the electrolytic solution tank. The photoelectric conversion layer and the first and second electrolyzing electrodes are connected together such that a photoelectromotive force of the photoelectric conversion layer is output to the first and second electrolyzing electrodes. The first electrolyzing electrode has a carbon dioxide reducing catalyst. The second electrolyzing electrode has an oxygen generating catalyst. The first and second electrolyzing electrodes are provided such that air bubbles are movable between the first and second electrolyzing electrodes. Additionally, the first and second electrolyzing electrodes have a comb-type structure having a trunk part and a plurality of branch parts extending from the trunk part, respectively. A branch part of the first electrolyzing electrode is arranged between two branch parts of the second electrolyzing electrode. A branch part of the second electrolyzing electrode is arranged between two branch parts of the first electrolyzing electrode.

In addition to these, a hydrogen-oxygen gas generating electrode is suggested in JP-2005-171383A as a device that decomposes an electrolytic aqueous solution to produce oxygen and hydrogen. A hydrogen-oxygen gas generating electrode of JP-2005-171383A includes an anode plate group consisting of a plurality of anode plates that are separated from each other and are lined up in parallel, and a cathode plate group consisting of a plurality of cathode plates that face the plurality of anode plates, respectively. A gap that introduces water is secured between the anode plate group and the cathode plate group. A pair of anode segments is formed by folding back an anode plate in a substantial U-shape, a pair of cathode segment is formed by folding back a cathode plate in a substantial U-shape type, and the pair of anode segments and the pair of cathode segments are alternately inserted therebetween. In JP-2005-171383A, power sources are respectively connected to the anode plate group and the cathode plate group, and the water introduced into the gap is electrolyzed by applying positive and negative electric charges to the anode plate group and the cathode plate group, respectively.

### SUMMARY OF THE INVENTION

As described above, in JP4406689B, light strikes only upon one cell out of the hydrogen generation cells, and an oxygen generation cell. Therefore, there is a problem that the efficiency at which hydrogen and oxygen are obtained from water is bad. Additionally, in JP-2004-256378A, a comb-type electrode is used, but the comb-type electrode is only one electrode and the distance thereof from a counter electrodes is far. Therefore, there is a problem that the efficiency of electrolysis is bad.

Although an electrode of the comb-type structure is shown in JP-2013-253269A, first and second electrolyzing electrodes are provided on a back surface side of the photoelectric conversion layer, and a configuration in which the electrodes are irradiated with light is not provided. Additionally, in JP-2005-171383A, there is a problem that the power sources are required for electrolysis of water.

An object of the invention is to solve the problems based on the aforementioned related art and provide an artificial photosynthesis module having excellent in electrolysis efficiency.

In order to achieve the above object, there is provided an artificial photosynthesis module used for decomposition of an electrolytic aqueous solution into hydrogen and oxygen by light. The artificial photosynthesis module comprises a hydrogen generation electrode having a first protrusion and a first recess alternately arranged thereon, and an oxygen generation electrode having a second protrusion and a second recess alternately arranged thereon. The hydrogen generation electrode and the oxygen generation electrode are in contact with the electrolytic aqueous solution. At least one electrode of the hydrogen generation electrode or the oxygen generation electrode includes a conductive layer and a photocatalyst layer provided on the conductive layer. The hydrogen generation electrode and the oxygen generation electrode are arranged side by side, the second protrusion of the oxygen generation electrode faces the first recess of the hydrogen generation electrode in an arrangement direction, and the first protrusion faces the second recess in the arrangement direction.

It is preferable that the hydrogen generation electrode and the oxygen generation electrode are configured such that the second protrusion of the oxygen generation electrode enters the first recess of the hydrogen generation electrode and the first protrusion enters the second recess.

It is preferable that an ion conduction layer is arranged between the hydrogen generation electrode and the oxygen generation electrode. For example, the hydrogen generation electrode and the oxygen generation electrode are arranged on the same plane. Additionally, for example, the hydrogen generation electrode and the oxygen generation electrode are arranged at different positions in a direction perpendicular to the same plane. In this case, the hydrogen generation electrode is provided above the oxygen generation electrode.

It is preferable that the hydrogen generation electrode is formed on a front surface of the ion conduction layer, and the oxygen generation electrode is formed on a back surface of the ion conduction layer.

For example, the shape of the first protrusion and the first recess and the shape of the second protrusion, and the second recess are a triangular shape or a rectangular shape.

Additionally, it is preferable that the width of the second protrusion of the oxygen generation electrode is larger than the width of the first protrusion of the hydrogen generation electrode.

For example, the width of the first protrusion and the width of the second protrusion are 10 μm to 3 mm, and the width of the second recess and the width of the first recess are 12 μm to 5 mm.

Additionally, the hydrogen generation electrode and the oxygen generation electrode can be formed using a screen printing method, an ink jet method, or a photo-etching method. It is preferable that photocatalyst layer has a co-catalyst provided on a surface thereof.

According to the invention, the artificial photosynthesis module having excellent electrolysis efficiency can be obtained.

### BRIEF DESCRIPTION OF THE DRAWINGS

FIG. 1 is a schematic plan view illustrating a water electrolysis system having artificial photosynthesis modules of an embodiment of the invention.

FIG. 2 is a schematic plan view illustrating an electrode configuration of an artificial photosynthesis module of the embodiment of the invention.

FIG. 3A is a side view illustrating the electrode configuration of the artificial photosynthesis module of the embodiment of the invention, and FIG. 3B is a side view illustrating another example of the electrode configuration of the artificial photosynthesis module of the embodiment of the invention.

FIG. 4 is a schematic sectional view illustrating the configuration of a hydrogen generation electrode of the artificial photosynthesis module of the embodiment of the invention.

FIG. 5 is a schematic sectional view illustrating the configuration of an oxygen generation electrode of the artificial photosynthesis module of the embodiment of the invention.

FIG. 6 is a side view illustrating another electrode configuration of the artificial photosynthesis module of the embodiment of the invention.

FIG. 7A is a plan view illustrating a strip-shaped electrode, and FIG. 7B is a plan view illustrating a square electrode.

FIG. 8 is a graph illustrating effects of differences between electrode configurations of artificial photosynthesis modules.

FIG. 9 is a graph illustrating effects of differences between the sizes of electrodes of the artificial photosynthesis modules.

FIG. 10 is a graph illustrating effects of ion conduction layers of the artificial photosynthesis modules.

### DESCRIPTION OF THE PREFERRED EMBODIMENTS

Hereinafter, an artificial photosynthesis module of the invention will be described in detail with reference to preferred embodiments illustrated in the attached drawings. The invention is not limited to an embodiment of the artificial photosynthesis module to be described below.

In addition, in the following, “to” showing a numerical range includes numerical values described in on both sides thereof. For example, ε being a numerical value α to a numerical value β means that the range of ε is a range including the numerical value α and the numerical value β, and if these are expressed by mathematical symbols, α≦ε≦β is satisfied.

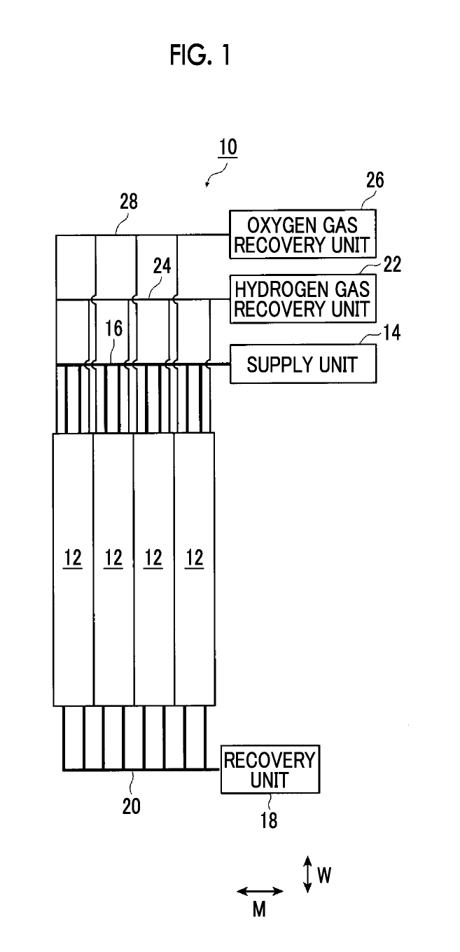

FIG. 1 is a schematic plan view illustrating a water electrolysis system having the artificial photosynthesis module of the embodiment of the invention.

As illustrated in FIG. 1, the water electrolysis system 10 (hereinafter simply referred to a system 10) has, for example, a plurality of artificial photosynthesis modules 12. The artificial photosynthesis modules 12 extend the direction W, and are arranged side by side in a direction M orthogonal to the direction W. In addition, in the system 10, the number of the artificial photosynthesis modules 12 is not particularly limited, and may be at least one.

The artificial photosynthesis modules 12 receive light, decompose an electrolytic aqueous solution AQ to be described below into hydrogen and oxygen, and generate hydrogen gas and oxygen gas. The artificial photosynthesis modules 12 will be described below in detail.

Here, the electrolytic aqueous solution AQ is, for example, a liquid having H₂O as a main component, and may be distilled water, or may be an aqueous solution using water as a solvent and including a solute. The water may be, for example, an electrolytic solution that is an aqueous solution including an electrolyte or may be cooling water used in a cooling tower or the like. The electrolytic solution is, for example, an aqueous solution including an electrolyte, and for example, is strong alkali (KOH (potassium hydroxide)), a polymer electrolyte (Nafion (registered trademark)), an electrolytic solution including 0.1 M of H₂SO₄, a 0.1 M sodium sulfate electrolytic solution, a 0.1 M potassium phosphate buffer solution, or the like.

The system 10 has a supply unit 14 for supplying the electrolytic aqueous solution AQ to the artificial photosynthesis modules 12, and a recovery unit 18 that recovers the electrolytic aqueous solution AQ discharged from the artificial photosynthesis module 12.

As the supply unit 14 and the recovery unit 18, well-known supply devices, such as a pump, are available, and well-known water recovery devices, such as a tank, are available.

The supply unit 14 is connected to the artificial photosynthesis modules 12 via a supply pipe 16, and the recovery unit 18 is connected to the artificial photosynthesis modules 12 via a recovery pipe 20. The electrolytic aqueous solution AQ may be recycled by circulating the electrolytic aqueous solution AQ recovered in the recovery unit 18 to the supply unit 14.

Methods of supplying the electrolytic aqueous solution AQ are not particularly limited, and the electrolytic aqueous solution AQ may be made to flow in parallel on electrode surfaces such that the flow of the electrolytic aqueous solution AQ may become a laminar flow on the electrode surfaces. In this case, a honeycomb straightening plate may be further provided. Additionally, the electrolytic aqueous solution AQ may be supplied so as to swirl on the electrode surfaces. In this case, for example, the electrolytic aqueous solution AQ is supplied toward the electrode surfaces without providing the straightening plate or the like.

Moreover, the system 10 has a hydrogen gas recovery unit 22 that recovers the hydrogen gas generated in the artificial photosynthesis modules 12, and an oxygen gas recovery unit 26 that recovers the oxygen gas generated in the artificial photosynthesis modules 12.

The hydrogen gas recovery unit 22 is connected to the artificial photosynthesis modules 12 via a hydrogen pipe 24, and the oxygen gas recovery unit 26 is connected to the artificial photosynthesis modules 12 via an oxygen pipe 28.

The configuration of the hydrogen gas recovery unit 22 is not particularly limited if hydrogen gas can be recovered. For example, devices using an adsorption method, a diaphragm method, and the like are available. The configuration of the oxygen gas recovery unit 26 is not particularly limited if oxygen gas can be recovered. For example, devices using an adsorption method are available.

In addition, the system 10 may be inclined at a predetermined angle with respect to the direction W. Accordingly, the electrolytic aqueous solution AQ is apt to move to the recovery pipe 20 side, and the efficiency of generation of hydrogen gas and oxygen gas can be made high. The hydrogen gas and the oxygen gas are also apt to move to the supply pipe 16 side, and the hydrogen gas and the oxygen gas can be efficiently recovered.

Although the hydrogen gas recovery unit 22 and the oxygen gas recovery unit 26 are provided on the supply pipe 16 side of the supply unit 14, the invention is not limited to this, and the hydrogen gas recovery unit 22 and the oxygen gas recovery unit 26 may be provided on the recovery pipe 20 side of the recovery unit 18.

Next, an artificial photosynthesis module 12 that constitutes the system 10 will be described in detail.

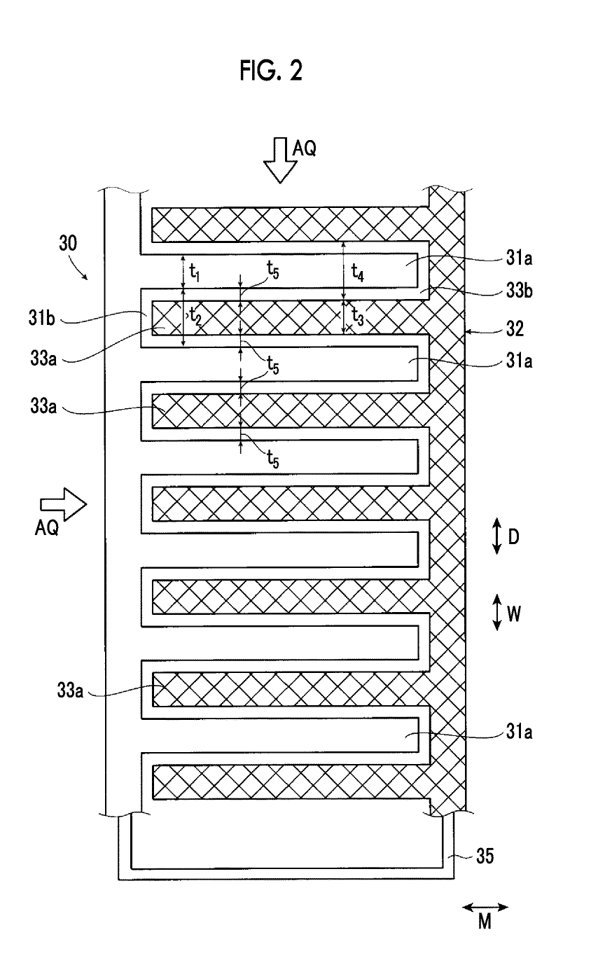

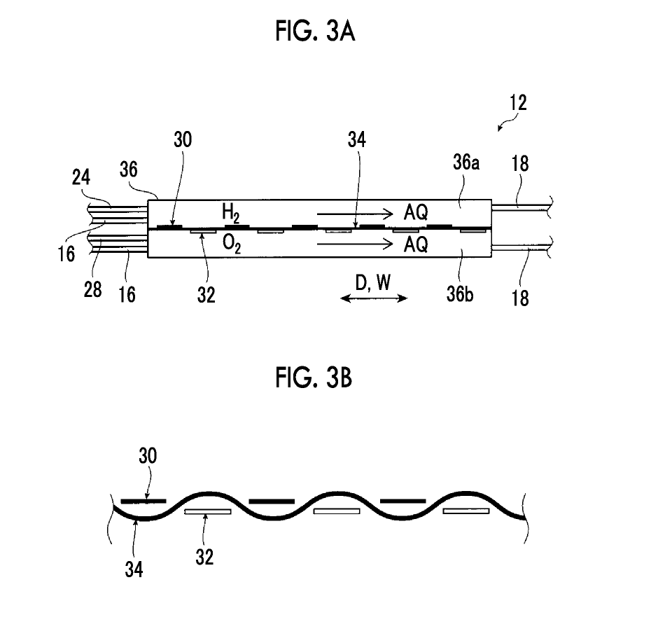

FIG. 2 is a schematic plan view illustrating an electrode configuration of the artificial photosynthesis module of the embodiment of the invention, FIG. 3A is a side view illustrating the electrode configuration of the artificial photosynthesis module of the embodiment of the invention, and FIG. 3B is a side view illustrating another example of the electrode configuration of the artificial photosynthesis module of the embodiment of the invention.

As illustrated in FIG. 2, the artificial photosynthesis module 12 has a hydrogen generation electrode 30 and an oxygen generation electrode 32. The hydrogen generation electrode 30 has an oblong first protrusion 31a and an oblong first recess 31b, and the first protrusion 31a and the first recess 31b are alternately arranged in a direction D. The oxygen generation electrode 32 has an oblong second protrusion 33a and an oblong second recess 33b, and the second protrusion 33a and the second recess 33b are alternately arranged in the direction D. The direction D is a direction parallel to the above-described direction W.

The hydrogen generation electrode 30 and the oxygen generation electrode 32 are arranged side by side, the first protrusion 31a enters the second recess 33b, and the second protrusion 33a enters the first recess 31b. The hydrogen generation electrode 30 and the oxygen generation electrode 32 illustrated in FIG. 2 are referred to as wedge electrodes or comb teeth electrodes in which the first protrusion 31a and the second protrusion 33a are equivalent to comb teeth.

Although gaps are formed on both sides of the first protrusion 31a in the direction D between second recess 33b and the first protrusion 31a, the gaps on both sides may be the same as each other or may be different from each other. Additionally, although gaps are formed on both sides of the second protrusion 33a in the direction D between the first recess 31b and the second protrusion 33a, even in this case, the gaps on both sides may be the same as each other or may be different from each other.

In the artificial photosynthesis module 12, the electrolytic aqueous solution AQ is made to flow in a direction parallel to the direction D, that is, so as to cross the first protrusion 31a and the second protrusion 33a. However, the invention is not limited to this. For example, the electrolytic aqueous solution AQ may be made to flow in a direction orthogonal to the direction D, that is, in a direction in which the first protrusion 31a and the second protrusion 33a extend.

In addition, making the electrolytic aqueous solution AQ flow so as to cross the first protrusion 31a and the second protrusion 33a is referred to as a crossing flow. In addition, making the electrolytic aqueous solution AQ flow in the direction in which the first protrusion 31a and the second protrusion 33a extend is referred to as a parallel flow.

The hydrogen generation electrode 30 and the oxygen generation electrode 32 are short-circuited by, for example, a wiring line 35. In the hydrogen generation electrode 30, power is generated by radiation of light as will be described below in detail. Accordingly, an electric current generated in the hydrogen generation electrode 30 by the radiation of light flows to the oxygen generation electrode 32, and the electrolytic aqueous solution AQ is electrolyzed in the hydrogen generation electrode 30 and the oxygen generation electrode 32, so that hydrogen and oxygen can be obtained.

Although the first protrusion 31a and the first recess 31b, and the second protrusion 33a and the second recess 33b all have an oblong shape, the invention is not limited to this. For example, a rectangular shape or a triangular shape other than the oblong shape may be used.

Additionally, although the first protrusion 31a enters the second recess 33b and the second protrusion 33a enters the first recess 31b, the invention is not limited to this, and the first protrusion and the second protrusion may not enter. If the hydrogen generation electrode 30 and the oxygen generation electrode 32 are arranged side by side, the second protrusion 33a of the oxygen generation electrode 32 faces the first recess 31b of the hydrogen generation electrode 30 in an arrangement direction, and the first protrusion 31a faces the second recess 33b in the arrangement direction, the arrangement form of the hydrogen generation electrode 30 and the oxygen generation electrode 32 is not particularly limited.

It is preferable that the first protrusion 31a enters the second recess 33b and the second protrusion 33a enters the first recess 31b because the installation area of the overall electrodes can be made small.

In the hydrogen generation electrode 30 and the oxygen generation electrode 32, it is preferable that, when the width of the first protrusion 31a is defined as t₁ and the width of the second protrusion 33a is defined as t₃, the width t₁ and the width t₃ are 10 μm to 3 mm. It is preferable that, when the width of the first recess 31b is defined as t₂ and the width of the second recess 33b is defined as t₄, the width t₂ and the width t₄ are 12 μm to 5 mm.

It is preferable that, when both the gap spacing between the second recess 33b and the first protrusion 31a and gap spacing between the first recess 31b and the second protrusion 33a is defined as t₅, the gap spacing t₅ is 1 μm to 1 mm. The gap spacing t₅ is expressed by (Width t₄-Width t₁)/2, and (Width t₂-Width t₃)/2.

If the width t₁ of the first protrusion 31a the width t₃ of the second protrusion 33a, the width t₂ of the first recess 31b, and the width t₄ of the second recess 33b are in the above-described ranges, the efficiency of electrolysis can be made higher.

In addition, the width t₁ of the first protrusion 31a and the width t₃ of the second protrusion 33a are also referred to as comb tooth width.

Since oxygen generation efficiency is not the same as hydrogen generation efficiency, the area of the hydrogen generation electrode 30 and the area of the oxygen generation electrode 32 are not necessarily the same. It is necessary to change the area of the hydrogen generation electrode 30 and the area of the oxygen generation electrode 32, according to the amounts of hydrogen and oxygen intended to obtain. In the invention, it is preferable that the width t₃ of the second protrusion 33a of the oxygen generation electrode 32 is larger than the width t₁ of the first protrusion 31a of the hydrogen generation electrode 30. Accordingly, the amounts of hydrogen and oxygen to be generated can be approximately equal amounts.

In the artificial photosynthesis module 12, as illustrated in FIG. 3A, the hydrogen generation electrode 30 and the oxygen generation electrode 32 are housed within a container 36, and an ion conduction layer 34 is arranged between the hydrogen generation electrode 30 and the oxygen generation electrode 32. In this case, the hydrogen generation electrode 30 and the oxygen generation electrode 32 are arranged at different positions in a direction perpendicular to the same plane, and in the arrangement direction, the second protrusion 33a of the oxygen generation electrode 32 faced the first recess 31b of the hydrogen generation electrode 30, and the first protrusion 31a faces the second recess 33b.

Additionally, for example, a configuration in which the hydrogen generation electrode 30 is formed on a front surface of the ion conduction layer 34 and the oxygen generation electrode 32 is formed on a back surface of the ion conduction layer 34 may be adopted.

The container 36 is partitioned into a space 36a having the hydrogen generation electrode 30 and a space 36b having the oxygen generation electrode 32 by the ion conduction layer 34.

The container 36 constitutes an outer shell of the artificial photosynthesis module 12, and the configuration thereof is not be particularly limited if the electrolytic aqueous solution AQ can be held inside the container without leaking and the light from the outside can be transmitted through the container so that the hydrogen generation electrode 30 and the oxygen generation electrode 32 can be irradiated with the light. The supply pipe 16 is connected to the container 36 at one end of each of the spaces 36a and 36b. Additionally, at the one end, the hydrogen pipe 24 is connected to the space 36a and the oxygen pipe 28 is connected to the space 36b. The recovery pipe 20 is connected to the other end of the container.

In the artificial photosynthesis module 12, hydrogen and oxygen can be separately recovered by being partitioned into the space 36a and the space 36b by the ion conduction layer 34. Accordingly, a separation step for hydrogen and oxygen, and a separation membrane become unnecessary, and recovery of hydrogen and oxygen can be made easy. Additionally, since hydrogen and oxygen can be separately recovered, there is no danger of hydrogen explosion and safety is high. Moreover, facilities and steps for countermeasures against explosion are unnecessary, and facility costs can also be reduced.

In addition, it is preferable that the hydrogen generation electrode 30 is arranged above the oxygen generation electrode 32. Accordingly, hydrogen can move to above the space 36a, and recovery of hydrogen can be made still easier.

In addition, in a case where the hydrogen generation electrode 30 are arranged below the oxygen generation electrode 32, generated hydrogen permeates the upper ion conduction layer 34, and moves to the oxygen generation electrode 32 side. However, this can be prevented by arranging the hydrogen generation electrode 30 above the oxygen generation electrode 32.

The ion conduction layer 34 allows hydrogen to permeate therethrough, for example, a proton transportation membrane is used, specifically, Nafion (registered trademark) is used. Besides this, for example, a membrane filter, a porous plastic, porous glass, non-woven paper, or the like can be used for the ion conduction layer 34.

For example, the ion conduction layer 34 becomes transparent if this the ion conduction layer gets wet in the electrolytic aqueous solution AQ, and the oxygen generation electrode 32 is irradiated with the light from the outside. As the ion conduction layer 34 that becomes transparent if getting wet in the electrolytic aqueous solution AQ, there is a membrane filter made by Merck KGaA.

The arrangement of the ion conduction layer 34 is not limited to one arranged between the hydrogen generation electrode 30 and the oxygen generation electrode 32. For example, as illustrated in FIG. 3B, the ion conduction layer may be arranged so as to be sewn between the hydrogen generation electrode 30 and the oxygen generation electrode 32. Even in this case, it is preferable that the hydrogen generation electrode 30 is arranged above the oxygen generation electrode 32.

In addition, the ion conduction layer 34 may not be provided. In this case, the hydrogen generation electrode 30 and the oxygen generation electrode 32 may be arranged on the same plane, or may be arranged at different positions in the direction perpendicular to the same plane.

The hydrogen generation electrode 30 and the oxygen generation electrode 32 can be formed using a screen printing method, an ink jet method, or a photo-etching method. In a case where the hydrogen generation electrode and the oxygen generation electrode are thin, these electrodes may be formed by vapor phase film deposition or pattern printing, and in a case where the hydrogen generation electrode and the oxygen generation electrode are thick, an electrode base material made of conductive metals is machined, and a photocatalyst and a co-catalyst are carried and supported thereon.

In the hydrogen generation electrode 30 and the oxygen generation electrode 32, for example, titanium is used for the base material. However, the invention is not limited to this, and conductive metals with low electric resistance can be used. This conductive metal with low electric resistance is, for example, niobium, zirconium, tantalum, nickel, molybdenum, stainless steel, or the like.

As methods of carrying and supporting the photocatalyst and the co-catalyst in the hydrogen generation electrode 30 and the oxygen generation electrode 32, for example, there are plating, a vacuum vapor deposition method, a vacuum sputtering method, a particle transfer method, an optical electrodeposition method, an electrophoresis method, a cast method, and the like. In the electrophoresis method, a catalyst can be carried and supported by applying a voltage to the hydrogen generation electrode 30 and the oxygen generation electrode 32 in a state where the hydrogen generation electrode 30 and the oxygen generation electrode 32 are incorporated into the artificial photosynthesis module 12. For this reason, as the hydrogen generation electrode 30 and the oxygen generation electrode 32, comb teeth structures are preferable.

The configuration of the hydrogen generation electrode 30 and the oxygen generation electrode 32 may be a configuration to be shown below without being limited to the above-described one.

Next, the configuration of the hydrogen generation electrode 30 will be described in detail.

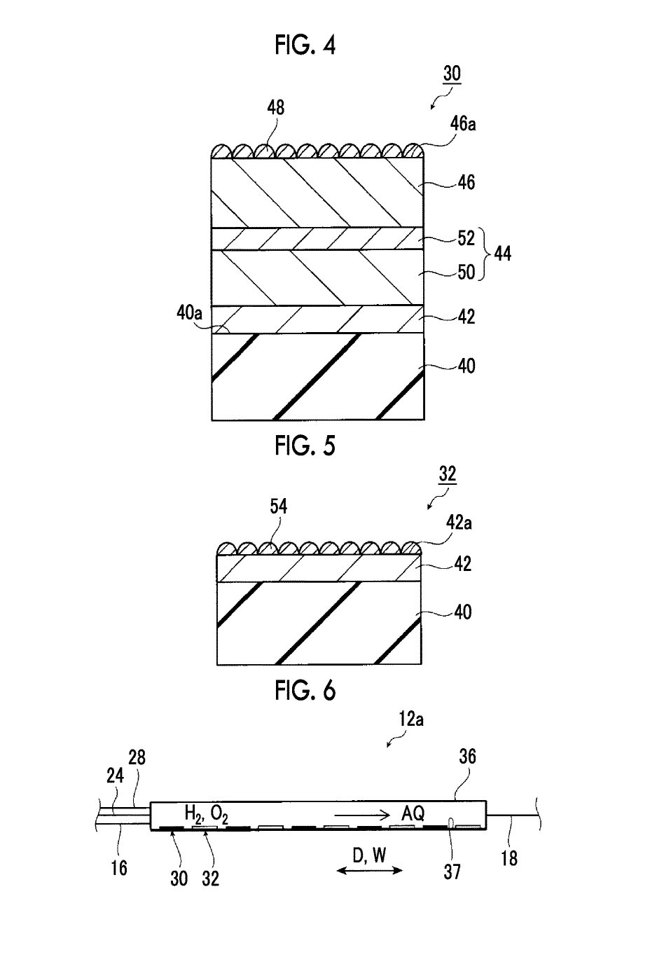

FIG. 4 is a schematic sectional view illustrating the configuration of the hydrogen generation electrode of the artificial photosynthesis module of the embodiment of the invention.

The hydrogen generation electrode 30 is formed on an insulating substrate 40, and has a conductive layer 42, a photocatalyst layer 44, and a functional layer 46. At the time of hydrogen generation, hydrogen is generated with the hydrogen generation electrode 30 in contact with the electrolytic aqueous solution AQ.

The insulating substrate 40 is configured to support the hydrogen generation electrode 30 and have electrical insulation. Although the insulating substrate 40 is not particularly limited, for example, a soda lime glass substrate (hereinafter referred to as an SLG substrate) or a ceramic substrate can be used. Additionally, an insulating substrate in which an insulating layer is formed on a metal substrate can be used as the insulating substrate 40. Here, as the metal substrate, a metal substrate, such as an Al substrate or a steel use stainless (SUS) substrate, or a composite metal substrate, such as a composite Al substrate made of a composite material of Al, and for example, other metals, such as SUS, is available. in addition, the composite metal substrate is a kind of the metal substrate, and the metal substrate and the composite metal substrate are collectively and simply referred to as a metal substrate. Moreover, a metal substrate with an insulating film having an insulating layer formed by anodizing a surface of the Al substrate or the like can also be used as the insulating substrate 40. The insulating substrate 40 may be flexible or may not be flexible. In addition, in addition to the above-described substrates, for example, a glass plate made of high strain point glass, non-alkali glass, or the like, or a polyimide substrate can also be used as the insulating substrate 40.

The thickness of the insulating substrate 40 is not particularly limited, may be 20 μm to 20000 μm, is preferably 100 μm to 10000 μm, and is more preferably 1000 μm to 5000 μm. In addition, in a case where one including a copper indium gallium (di) selenide (CIGS) compound semiconductor is used as a p-type semiconductor layer 50, photoelectric conversion efficiency is improved if alkali ions (for example, sodium (Na) ions: Na+) are supplied to the insulating substrate 40 side. Thus, it is preferable to provide an alkali supply layer that supplies the alkali ions to a surface 42a of the insulating substrate 40. In addition, in the case of the SLG substrate, the alkali supply layer is unnecessary.

In the hydrogen generation electrode 30 illustrated in FIG. 4, a co-catalyst 48 is formed on a surface 46a of the functional layer 46. The co-catalyst 48 may be formed, for example, in the shape of islands so as to be scattered.

The co-catalyst 48 can be formed of single substances constituted with, for example, Pt, Pd, Ni Au, Ag, Ru Cu, Co, Rh, Ir, Mn, or the like, alloys obtained by combining these single substances, and oxides of these single substances, for example, NiOₓ, and RuO₂. Additionally, the size of the co-catalyst 48 is not particularly limited, and is preferably 0.5 nm to 1 μm.

In addition, methods for forming the co-catalyst 48 are not particularly limited, and the co-catalyst 48 can be formed by a coating baking method, an optical electrodeposition method, a sputtering method, an impregnating method, and the like. Although it is preferable to provide the co-catalyst 48 on the surface 46a of the functional layer 46, the co-catalyst 48 may not be provided in a case where generation of sufficient hydrogen gas is possible.

The conductive layer 42 applies a voltage to the photocatalyst layer 44. Although the conductive layer 42 is not particularly limited as long as the conductive layer has conductivity, the conductive layer 42 is made of, for example, metals, such as Mo, Cr, and W, or combinations thereof The conductive layer 42 may have a single-layer structure, or may have a laminated structure, such as a two-layer structure. Among these, it is preferable that the conductive layer 42 is made of Mo. Although the film thickness of the conductive layer 42 is generally about 800 nm, it is preferable that the thickness of the conductive layer 42 is preferably 400 nm to 1 μm.

The photocatalyst layer 44 generates an electromotive force. The photocatalyst layer 44 has the p-type semiconductor layer 50 and an n-type semiconductor layer 52, and the p-type semiconductor layer 50 forms a pn junction at an interface between the p-type semiconductor layer 50 and the n-type semiconductor layer 52.

The photocatalyst layer 44 is a layer that absorbs the light which has been transmitted through the functional layer 46 and the n-type semiconductor layer 52 and has reached the photocatalyst layer, and generates holes on a p side and electrons on an n side. The p-type semiconductor layer 50 has a photoelectric conversion function. In the p-type semiconductor layer 50, holes generated in the pn junction are moved from the p-type semiconductor layer 50 to the conductive layer 42 side, and electrons generated in the pn junction are moved from the n-type semiconductor layer 52 to the functional layer 46 side. As for the film thickness of the p-type semiconductor layer 50, 0.5 μm to 3.0 μm is preferable, and 1.0 μm to 2.0 μm is particularly preferable.

It is preferable that the p-type semiconductor layer 50 is constituted with, for example, a CIGS compound semiconductor or a copper zinc tin sulfide (CZTS) compound semiconductor of Cu₂ZnSnS₄ or the like, which has a chalcopyrite crystal structure. The CIGS compound semiconductor layer may be constituted with CuInSe₂ (CIS), CuGaSe₂ (CGS), or the like as well as Cu(In, Ga)Se₂ (CIGS).

In addition, as methods for forming the CIGS layer, 1) a multi-source vapor deposition method, 2) a selenide method, 3) a sputtering method, 4) a hybrid sputtering method, 5) a mechanochemical process method, and the like are known.

Other methods for forming the CIGS layer include a screen printing method, a proximity sublimating method, a metal organic chemical vapor deposition (MOCVD) method, a spraying method (wet film-forming method), and the like. For example, in the screen printing method (wet film-forming method), a spraying method (wet film-forming method), a molecular beam epitaxy (MBE) method, or the like, crystal having a desired composition can be obtained by forming a particulate film including an 11 group element, a 13 group element, and a 16 group element on a substrate, and executing thermal decomposition processing (may be thermal decomposition processing in a 16 group element atmosphere in this case) or the like (JP1997-74065 (JP-H09-74065A), JP1997-74213A (JP-H09-74213A), or the like).

The n-type semiconductor layer 52 forms the pn junction at the interface between the n-type semiconductor layer 52 and the p-type semiconductor layer 50 as described above. Additionally, light is transmitted through the n-type semiconductor layer 52 in order to make the light incident on the functional layer 46 reach the p-type semiconductor layer 50.

It is preferable that the n-type semiconductor layer 52 is foamed of one including metal sulfide including at least one kind of metallic element selected from a group consisting of, for example, Cd, Zn, Sn, and In, such as CdS, ZnS, Zn(S, O), and/or Zn (S, O, OH), SnS, Sn (S, O), and/or Sn (S, O, OH), InS, In (S, O), and/or In (S, O, OH). The film thickness of the n-type semiconductor layer 52 is preferably 10 nm to 2 μm, and more preferably, 15 nm to 200 nm. The n-type semiconductor layer 52 is formed by, for example, a chemical bath deposition method.

In addition, a window layer, for example, may be provided between the n-type semiconductor layer 52 and the functional layer 46. This window layer is constituted with, for example, a ZnO layer with a thickness of about 10 nm.

If a pn junction consisting of an inorganic semiconductor can be formed, a photolysis reaction of water can be caused, and hydrogen can be generated, the configuration of the photocatalyst layer 44 is not particularly limited.

For example, photoelectric conversion elements used for solar battery cells that constitute a solar battery are preferably used. As such photoelectric conversion elements, in addition to those using the above-described CIGS compound semiconductor or CZTS compound semiconductor such as Cu₂ZnSnS₄, thin film silicon-based thin film type photoelectric conversion elements, CdTe-based thin film type photoelectric conversion elements, dye-sensitized thin film type photoelectric conversion elements, or organic thin film type photoelectric conversion elements can be used.

The functional layer 46 prevents entering of moisture into the inside of the photocatalyst layer 44, and inhibits formation of bubbles inside the photocatalyst layer 44. Transparency, water resistance, water impermeability, and conductivity are required for the functional layer 46. The durability of the hydrogen generation electrode 30 improves by the functional layer 46. The functional layer 46 supplies electrons to hydrogen ions (protons) H⁺ ionized from moisture molecules to generate hydrogen molecules, that is hydrogen gas (2H⁺+2e⁻→₂ ), and the surface 46a thereof functions as a hydrogen gas generation surface. Hence, the functional layer 46 constitutes a hydrogen gas generation region.

It is preferable that the functional layer 46 are formed of, for example, metals, conductive oxides (of which the overvoltage is equal to or lower than 0.5 V), or composites thereof. More specifically, transparent electroconductive films made of ZnO that is doped with indium tin oxide (ITO), Al, B, Ga, In, or the like, or IMO (In₂O₃ to which Mo is added) can be used for the functional layer 46. The functional layer 46 may have a single-layer structure, or may have a laminated structure, such as a two-layer structure. Additionally, the thickness of the functional layer 46 is not particularly limited, and is preferably 10 nm to 1000 nm and more preferably 50 nm to 500 nm.

In addition, methods for forming the functional layer 46 are not particularly limited, and the functional layer 46 can be formed by gaseous phase film-forming methods, such as an electron beam deposition method, a sputtering method, or a chemical vapor deposition (CVD) method, or a coating method. The functional layer 46 is not necessarily provided.

Next, the configuration of the oxygen generation electrode 32 will be described.

FIG. 5 is a schematic sectional view illustrating the configuration of the oxygen generation electrode of the artificial photosynthesis module of the embodiment of the invention.

In the oxygen generation electrode 32, the conductive layer 42 is formed on the insulating substrate 40, and a co-catalyst 54 for generating oxygen is formed on the surface 42a of the conductive layer 42. In this case, the co-catalyst 54 may be formed, for example, in the shape of islands so as to be scattered. The co-catalyst 54 for generating oxygen is made of, for example, IrO₂, CoOₓ, or the like.

Additionally, the size of the co-catalyst 54 for generating oxygen is not particularly limited, and is preferably 0.5 nm to 1 μm. In addition, methods for forming the co-catalyst 54 for generating oxygen are not particularly limited, and the co-catalyst can be formed by a coating baking method, a dipping method, an impregnating method, a sputtering method, a vapor deposition method, and the like. In addition, the co-catalyst 54 may not be formed in a case where sufficient generation of oxygen gas is possible.

Although the hydrogen generation electrode 30 is configured to have the photocatalyst in the above-described description, the invention is not limited to this. The oxygen generation electrode 32 may be configured to have a p-type semiconductor layer and an n-type semiconductor layer and have a photocatalyst that forms a pn junction.

In addition, the electrode configuration of the artificial photosynthesis module 12 is not limited to one illustrated in FIG. 3A, and may be a configuration illustrated in FIG. 6.

Here, FIG. 6 is a side view illustrating another electrode configuration of the artificial photosynthesis module of the embodiment of the invention. In addition, in an artificial photosynthesis module 12a illustrated in FIG. 6, the same components as the artificial photosynthesis module 12 illustrated in FIG. 3A will be designated by the same reference signs, and the detailed description thereof will be omitted.

The artificial photosynthesis module 12a illustrated in FIG. 6 is different from the artificial photosynthesis module 12 illustrated in FIG. 3A in that the ion conduction layer 34 is not provided within the container 36, and the hydrogen generation electrode 30 and the oxygen generation electrode 32 are arranged on a bottom surface 37 as illustrated in FIG. 2. Additionally, there is a difference in that the supply pipe 16 and the recovery pipe 20 are provided for each container 36. Since the other configuration is the same configuration as the artificial photosynthesis module 12 illustrated in FIG. 3A, the detailed description thereof will be omitted.

In the artificial photosynthesis module 12a illustrated in FIG. 6, the supply pipe 16 and the recovery pipe 20 do not need to be provided for each of the spaces 36a and 36b (to refer to FIG. 3A) and just have to be provided for the container 36. Therefore, the configuration of the artificial photosynthesis module 12a can be simplified. However, since hydrogen and oxygen are generated within the same space, a separation step for hydrogen and oxygen and a separation membrane are required, and recovery becomes complicated.

Additionally, the hydrogen generation electrode 30 and the oxygen generation electrode 32 may not be installed in the same plane like the bottom surface 37 illustrated in FIG. 6, for example, the hydrogen generation electrode 30 and the oxygen generation electrode 32 may be arranged apart from each other in a direction perpendicular to the bottom surface 37. Even in this case, it is preferable that the hydrogen generation electrode 30 is arranged above the oxygen generation electrode 32.

In the artificial photosynthesis module 12, by arranging the hydrogen generation electrode 30 and the oxygen generation electrode 32 side by side, both the hydrogen generation electrode 30 and the oxygen generation electrode 32 can be irradiated with light, and electrolysis efficiency can be made high. Additionally, the area of the hydrogen generation electrode 30 and the oxygen generation electrode 32 in contact with the electrolytic aqueous solution AQ can be enlarged by being configured such that the recess and the protrusion are provided therein. Moreover, by arranging the hydrogen generation electrode 30 and the oxygen generation electrode 32 side by side, making the first protrusion 31a enter the second recess 33b, and making the second protrusion 33a enter the first recess 31b, the installation area of the overall electrodes can be made small, with the area of the electrodes in contact with the electrolytic aqueous solution AQ being maintained.

Additionally, since the artificial photosynthesis module 12 has only a configuration in which the hydrogen generation electrode 30 and the oxygen generation electrode 32 are provided, the configuration can be simplified. Accordingly, a manufacturing process can be simplified and manufacturing costs can also be reduced.

In addition, the hydrogen generation electrode 30 and the oxygen generation electrode 32 may have the same size, or may have different sizes. Additionally, the hydrogen generation electrode 30 and the oxygen generation electrode 32 may be symmetrical or asymmetrical. The size of the hydrogen generation electrode 30 and the oxygen generation electrode 32 is appropriately determined according to the electrolysis efficiency.

Additionally, bubbles are generated in the electrolytic aqueous solution AQ by the hydrogen generated on the hydrogen generation electrode 30 and the oxygen generated on the oxygen generation electrode 32. The bubbles hinder radiation of light to the hydrogen generation electrode 30 and the oxygen generation electrode 32, and also reduce the electrolysis efficiency. For this reason, it is preferable that the generated bubbles are rapidly removed. For this reason, it is preferable that a flow rate at which the electrolytic aqueous solution AQ is supplied is a flow rate at which the generated bubbles can be removed.

In the hydrogen generation electrode 30 and the oxygen generation electrode 32 of the artificial photosynthesis module 12, although not illustrated, it is preferable to appropriately provide a protective film that is not dissolved in a weak acidic solution and a weak alkaline solution and has light permeability, water impermeability, and insulation, if necessary. The protective film can be made of, for example, SiO₂, SnO₂, Nb₂O₅, Ta2O₅, Al2O₃, Ga2O₃, and the like. The thickness of the protective film is not particularly limited, and is preferably 100 nm to 1000 nm.

In addition, methods for forming the protective film are not particularly limited, and the protective film can be formed by a radio frequency (RF) sputtering method, a direct current (DC) reactive sputtering method, the MOCVD method, and the like.

Additionally, the protective film is made of, for example insulating epoxy resin, insulating silicone resin, insulating fluororesin, or the like. In this case, the thickness of the protective film is not particularly limited, and is preferably 2 μm to 1000 μm.

The invention is basically configured as described above. Although the artificial photosynthesis module of the invention has been described above in detail, it is natural that the invention is not limited to the above embodiment, and various improvements and modifications may be made without departing from the scope of the invention.

### Example 1

Hereinafter, the effects of the artificial photosynthesis module of the invention will be described in detail.

In a first example, in order to confirm the effects of the electrode configuration of the invention, artificial photosynthesis modules of Example 1, Example 2, and Comparative Examples 1 to 4 illustrated below were made.

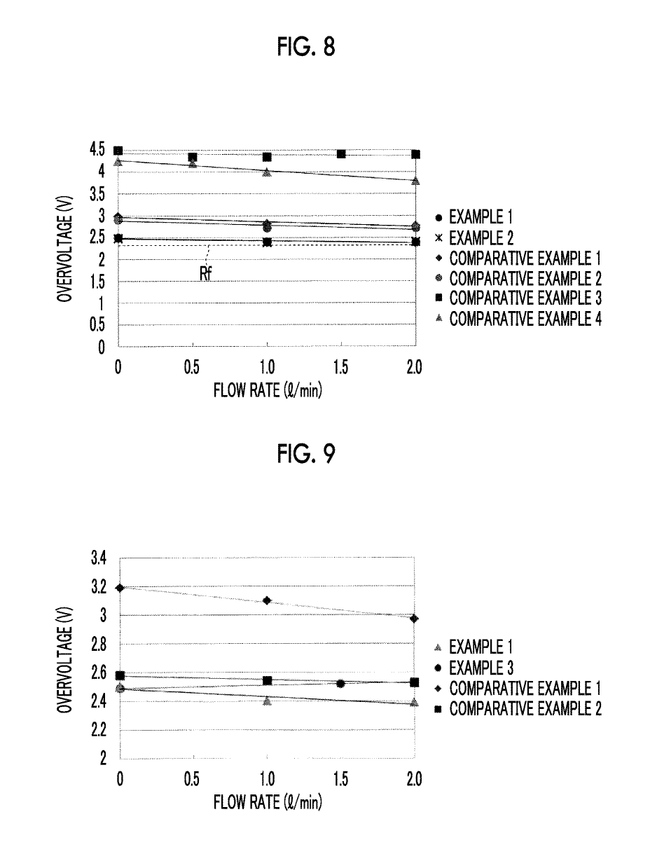

Arrival overvoltages (V) when making an electric current equivalent to 10% of the conversion efficiency flow to a hydrogen generation electrode and an oxygen generation electrode while supplying the electrolytic aqueous solution AQ to each of the artificial photosynthesis modules of Example 1, Example 2, and Comparative Examples 1 to 4 were measured as overvoltages. The results are illustrated in FIG. 8.

Here, FIG. 8 is a graph illustrating effects of differences between electrode configurations of the artificial photosynthesis modules.

In addition, Potentiostat (HZ-7000 made by the Hokuto Denko Corp.) was used for supply of the electric current to the hydrogen generation electrode and the oxygen generation electrode.

In addition, the overvoltages are voltages obtained by subtracting a theoretical electrolysis voltage of water from a total electric potential of an anode and a cathode (the hydrogen generation electrode and the oxygen generation electrode) required for electrolysis of water (electrolytic aqueous solution). The results illustrated in FIG. 8 mean that the efficiency of electrolysis of the electrolytic aqueous solution is higher as the overvoltage is smaller. The electric current equivalent to 10% of the conversion efficiency is an electric current of which the current density reaches 8.13 mA/cm².

An electrolytic solution with 0.1 M of Na₂SO₄ and pH 9.5 was used for the electrolytic aqueous solution AQ. The liquid thickness of the electrolytic aqueous solution AQ was set to 5 mm, and the flow rate of the electrolytic aqueous solution AQ was changed in units of 0.5 l/min between 0 l/min to 2.0 l/min. In addition, the flow rate of the electrolytic aqueous solution AQ being 0 l/min means a state where the electrolytic aqueous solution AQ is accumulated in an electrolytic bath.

Hereinafter, the artificial photosynthesis modules of Example 1, Example 2, and Comparative Examples 1 to 4 will be described. In addition, in any of the artificial photosynthesis modules, the hydrogen generation electrode and the oxygen generation electrode are arranged within a container in which an electrolytic aqueous solution inlet part and an electrolytic aqueous solution outlet part are provided. Hereinafter, unless otherwise mentioned, with respect to a method for supplying the electrolytic aqueous solution AQ, the electrolytic aqueous solution AQ is made to enter and leave such that the electrolytic aqueous solution inlet part and the electrolytic aqueous solution outlet part are parallel to parallel to electrode surfaces, and a honeycomb straightening plate was attached such that the flow of the electrolytic aqueous solution AQ becomes a laminar flow on the electrode surfaces.

### Example 1

An artificial photosynthesis module of Example 1 has a wedge electrode including the hydrogen generation electrode and the oxygen generation electrode illustrated in FIG. 2. In the hydrogen generation electrode and the oxygen generation electrode, respectively, the electrode dimensions are 32 mm×120 mm×Thickness 1.0 mm, comb teeth have Width 3 mm×Length 32 mm×Number of teeth 15, and the width between the comb teeth is 5 mm. The gap spacing of the hydrogen generation electrode and the oxygen generation electrode in a state where the comb teeth of the hydrogen generation electrode and the oxygen generation electrode are made to enter each other is 1.0 mm. The hydrogen generation electrode and the oxygen generation electrode are electrodes (Exeload EA: Japan Carlit Co., Ltd.) obtained by performing platinum plating treatment on the surface of a base material made of titanium. In addition, no ion conduction layer is provided.

In Example 1, the electrolytic aqueous solution AQ was made to flow in the direction D illustrated in FIG. 2. That is, the above flow is the crossing flow.

### Example 2

An artificial photosynthesis module of Example 2 has the same configuration as Example 1 except that the electrolytic aqueous solution AQ is made to flow in direction orthogonal to the direction D illustrated in FIG. 2, as compared to Example 1. For this reason, the detailed description thereof will be omitted. Example 2 has the parallel flow.

### Comparative Example 1

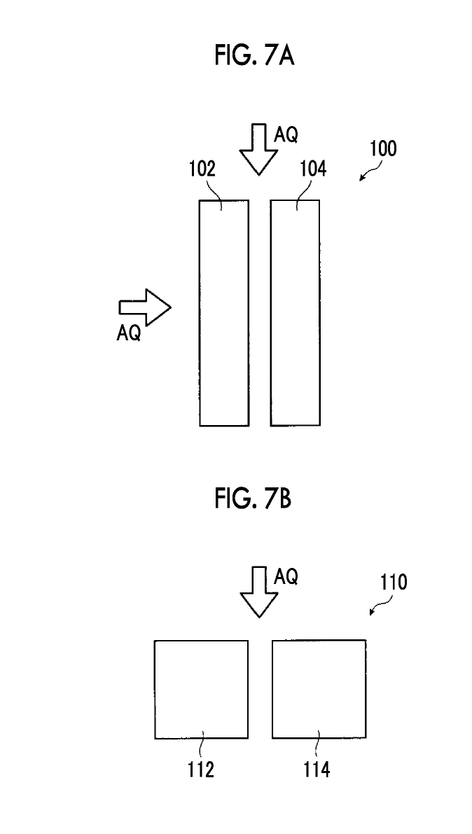

An artificial photosynthesis module of Comparative Example 1 has a strip-shaped electrode 100 illustrated in FIG. 7A. The strip-shaped electrode 100 has a strip-shaped hydrogen generation electrode 102 and a strip-shaped oxygen generation electrode 104. In the hydrogen generation electrode 102 and the oxygen generation electrode 104, the electrode dimensions have Width 15 mm×Length 100 mm×Thickness 1.0 mm, and a gap between the electrodes is 1.0 mm. The hydrogen generation electrode 102 and the oxygen generation electrode 104 of the strip-shaped electrode 100 are electrodes (Exeload EA: Japan Carlit Co., Ltd.) obtained by performing platinum plating treatment on the surface of a base material made of titanium. In addition, no ion conduction layer is provided.

In Comparative Example 1, the electrolytic aqueous solution AQ was made to flow so as to cross a length direction of the hydrogen generation electrode 102 and the oxygen generation electrode 104. Comparative Example 1 has the crossing flow.

### Comparative Example 2

Since an artificial photosynthesis module of Comparative Example 2 has the same configuration as Comparative Example 1 except that the electrolytic aqueous solution AQ is made to flow in the length direction of the hydrogen generation electrode 102 and the oxygen generation electrode 104 as compared to Comparative Example 1, the detailed description thereof will be omitted. Comparative Example 2 has the parallel flow.

### Comparative Example 3

An artificial photosynthesis module of Comparative Example 3 has n square electrode 110 illustrated in FIG. 7B. The square electrode 110 has a square hydrogen generation electrode 112 and a square oxygen generation electrode 114. In the hydrogen generation electrode 112 and the oxygen generation electrode 114, the electrode dimensions have 50 mm×50 mm×Thickness 1.0 mm, and a gap between the electrodes is 1.0 mm. The hydrogen generation electrode 112 and the oxygen generation electrode 114 of the square electrode 110 are electrodes (Exeload EA: Japan Carlit Co., Ltd.) obtained by performing platinum plating treatment on the surface of a base material made of titanium. In addition, no ion conduction layer is provided.

### Comparative Example 4

Since Comparative Example 4 has the same configuration as Comparative Example 3 except that the electrolytic aqueous solution is supplied so as to become turbulence, the detailed description thereof will be omitted. The electrolytic aqueous solution being supplied so as to become turbulence means that the electrolytic aqueous solution inlet part and the electrolytic aqueous solution outlet part are arranged so as to hit against the electrode surfaces perpendicularly thereto, there is also no straightening plate, and the electrolytic aqueous solution AQ becomes an uncontrolled flow so as to swirl within the container of the artificial photosynthesis module.

As illustrated in FIG. 8, in Examples 1 and 2 with the wedge electrode structure, the overvoltage was small, and a value near the electrolysis voltage (refer to reference sign Rf) in a case where Pt electrodes are arranged to face each other. Comparative Example 2 in which the electrolytic aqueous solution AQ is made to flow in the direction orthogonal to the direction D has a smaller overvoltage as compared to Comparative Example 1 in which the electrolytic aqueous solution AQ is made to flow in the direction D.

Meanwhile, Comparative Examples 1 to 4 have all a high overvoltage. Comparative Examples 3 and 4 of the square electrodes have a higher overvoltage than Comparative Examples 1 and 2 of the strip-shaped electrodes.

### Example 2

In a second example, effects of differences between the sizes of electrodes of artificial photosynthesis modules will be described.

FIG. 9 is a graph illustrating effects of differences between the sizes of the electrodes of the artificial photosynthesis modules.

In the second example, the effects of differences between the sizes of the electrodes were investigated using Example 1 of the first example, Comparative Examples 1 and 2, and Example 3 to be described below. Specifically, in the present example, the arrival overvoltages when an electric current was made to flow to the artificial photosynthesis modules of Examples 1 and 3 and Comparative Examples 1 and 2at a current density of 8.13 mA/cm² for 10 minutes were measured. The results are illustrated in FIG. 9.

In addition, in the present example, a method for measuring arrival overvoltages is the same as the above-described first example, and the same electrolytic aqueous solution as the first example is used as the electrolytic aqueous solution AQ, and the supply amount of the electrolytic aqueous solution AQ and a method for supplying the electrolytic aqueous solution are also same as those of the first example. Therefore, the detailed description thereof will be omitted. Hereinafter, Example 3 will be described.

### Example 3

An artificial photosynthesis module of Example 3 has the wedge electrode illustrated in FIG. 2, and the wedge electrode includes the hydrogen generation electrode and the oxygen generation electrode. As for the wedge electrode, a titanium film was formed on a glass substrate with a size of 20 mm×12 mm, and a pattern was formed in a wedge shape using photolithography, and then, a platinum film was formed on the surface of the wedge-shaped titanium film. The hydrogen generation electrode and the oxygen generation electrode are electrodes in which a platinum film (BAS Inc.) was formed on the surface of a titanium film. The comb teeth of the hydrogen generation electrode and the oxygen generation electrode have Width 0.01 mm (10 μm)×Length 2.0 mm×Number of teeth 65, and the width between the comb teeth is 0.02 mm (20 μm). The gap spacing of the hydrogen generation electrode and the oxygen generation electrode in a state where the comb teeth of the hydrogen generation electrode and the oxygen generation electrode are made to enter each other is 0.005 mm (5 μm). In addition, no ion conduction film is arranged between both the electrodes. Example 3 has the crossing flow.

As illustrated in FIG. 9, Example 1 in which the width of the comb teeth is 3 mm has a smallest overvoltage, and Example 3 in which the width of the comb teeth is 0.01 mm (10 micrometers) has the next smallest overvoltage. Comparative Examples 1 and 2 of the strip-shaped electrode having a width of 15 mm had all overvoltages larger than Examples 1 and 2.

### Example 3

In a third example, effects of differences between the sizes of ion conduction layers of artificial photosynthesis modules will be described.

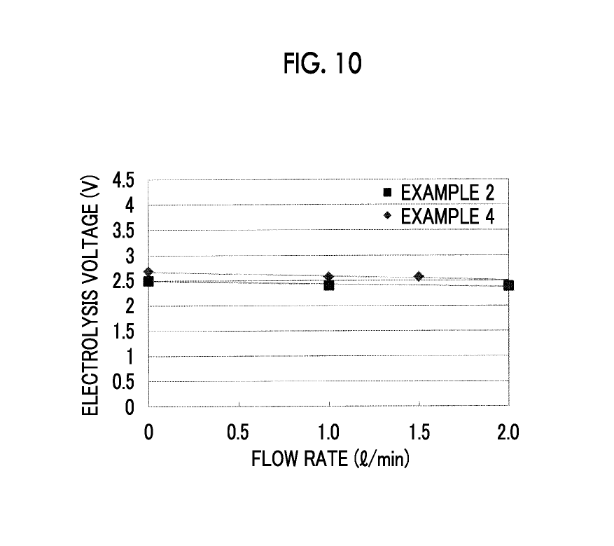

FIG. 10 is a graph illustrating effects of the ion conduction layers of the artificial photosynthesis modules.

In the third example, the effects of the ion conduction layers were investigated using Example 1 of the first example and Example 4 to be described below. Specifically, in the present example, electrolysis voltages (V) when an electric current equivalent to 10% of the conversion efficiency, that is, an electric current of which current density reaches 8.13 mA//cm² was made to flow while supplying the electrolytic aqueous solution to the artificial photosynthesis modules of Examples 1 and 4 were measured. The results are illustrated in FIG. 10.

In addition, the electrolysis voltages are total electric potentials of an anode and a cathode (the hydrogen generation electrode and the oxygen generation electrode) required for electrolysis of water (electrolytic aqueous solution).

In the present example, a method for measuring electrolysis voltages is the same as the method for measuring the arrival overvoltages the above-described first example, and the same electrolytic aqueous solution as the first example is used as the electrolytic aqueous solution AQ, and the supply amount of the electrolytic aqueous solution AQ and a method for supplying the electrolytic aqueous solution are also same as those of the first example. Therefore, the detailed description thereof will be omitted. Hereinafter, Example 4 will be described.

### Example 4

An artificial photosynthesis module of Example 4 has the wedge electrode illustrated in FIG. 2, and the wedge electrode includes the hydrogen generation electrode and the oxygen generation electrode. In the hydrogen generation electrode and the oxygen generation electrode, respectively, the electrode dimensions are 32 mm×120 mm×Thickness 1.0 mm, comb teeth have Width 3 mm×Length 32 mm×Number of teeth 15, and the width between the comb teeth is 5 mm. The gap spacing of the hydrogen generation electrode and the oxygen generation electrode in a state where the comb teeth of the hydrogen generation electrode and the oxygen generation electrode are made to enter each other is 1.0 mm. The hydrogen generation electrode and the oxygen generation electrode are electrodes (Exeload EA: Japan Carlit Co., Ltd.) obtained by performing platinum plating treatment on the surface of a base material made of titanium. In addition, a Nafion (registered trademark) film is arranged as an ion conduction layer between the hydrogen generation electrode and then oxygen generation electrode. The hydrogen generation electrode is arranged on the upper side of the ion conduction layer, and the oxygen generation electrode is arranged on the lower side of the ion conduction layer. In addition, Example 4 has the crossing flow.

As illustrated in FIG. 10, Example 1 with no ion conduction layer has a lower electrolysis voltage than Example 4 with the ion conduction layer. This is because the ion conduction layer becomes a resistor and the electrolysis voltage becomes high.

### EXPLANATION OF REFERENCES

10: water electrolysis system (system)

12: artificial photosynthesis module

14: supply unit

16: supply pipe

18: recovery unit

20: recovery pipe

22: hydrogen gas recovery unit

24: hydrogen pipe

26: oxygen gas recovery unit

28: oxygen pipe

30: hydrogen generation electrode

31a: first protrusion

31b: first recess

32: oxygen generation electrode

33a: second protrusion

33b: second recess

34: ion conduction layer

36: container

40: insulating substrate

42: conductive layer

44: photocatalyst layer

46: functional layer

48, 54: co-catalyst

What is claimed is:

1. An artificial photosynthesis module used for decomposition of an electrolytic aqueous solution into hydrogen and oxygen by light, the artificial photosynthesis module comprising:
a hydrogen generation electrode having a first protrusion and a first recess alternately arranged thereon, and an oxygen generation electrode having a second protrusion and a second recess alternately arranged thereon,
wherein the hydrogen generation electrode and the oxygen generation electrode are in contact with the electrolytic aqueous solution,
wherein at least one electrode of the hydrogen generation electrode or the oxygen generation electrode includes a conductive layer and a photocatalyst layer provided on the conductive layer, and
wherein the hydrogen generation electrode and the oxygen generation electrode are arranged side by side, the second protrusion of the oxygen generation electrode faces the first recess of the hydrogen generation electrode in an arrangement direction, and the first protrusion faces the second recess in the arrangement direction.

2. The artificial photosynthesis module according to claim 1,
wherein the hydrogen generation electrode and the oxygen generation electrode are configured such that the second protrusion of the oxygen generation electrode enters the first recess of the hydrogen generation electrode and the first protrusion enters the second recess.

3. The artificial photosynthesis module according to claim 1,
wherein an ion conduction layer is arranged between the hydrogen generation electrode and the oxygen generation electrode.

4. The artificial photosynthesis module according to claim 2,
wherein an ion conduction layer is arranged between the hydrogen generation electrode and the oxygen generation electrode.

5. The artificial photosynthesis module according to claim 1,
wherein the hydrogen generation electrode and the oxygen generation electrode are arranged on the same plane.

6. The artificial photosynthesis module according to claim 2,
wherein the hydrogen generation electrode and the oxygen generation electrode are arranged on the same plane.

7. The artificial photosynthesis module according to claim 1,
wherein the hydrogen generation electrode and the oxygen generation electrode are arranged at different positions in a direction perpendicular to the same plane.

8. The artificial photosynthesis module according to claim 2,
wherein the hydrogen generation electrode and the oxygen generation electrode are arranged at different positions in a direction perpendicular to the same plane.

9. The artificial photosynthesis module according to claim 3,
wherein the hydrogen generation electrode and the oxygen generation electrode are arranged at different positions in a direction perpendicular to the same plane.

10. The artificial photosynthesis module according to claim 7,
wherein the hydrogen generation electrode is provided above the oxygen generation electrode.

11. The artificial photosynthesis module according to claim 3,
wherein the hydrogen generation electrode is formed on a front surface of the ion conduction layer, and the oxygen generation electrode is formed on a back surface of the ion conduction layer.

12. The artificial photosynthesis module according to claim 1,
wherein the shape of the first protrusion and the first recess and the shape of the second protrusion, and the second recess are a triangular shape or a rectangular shape.

13. The artificial photosynthesis module according to claim 2,
wherein the shape of the first protrusion and the first recess and the shape of the second protrusion, and the second recess are a triangular shape or a rectangular shape.

14. The artificial photosynthesis module according to claim 12,
wherein the width of the second protrusion of the oxygen generation electrode is larger than the width of the first protrusion of the hydrogen generation electrode.

15. The artificial photosynthesis module according to claim 12,
wherein the width of the first protrusion and the width of the second protrusion are 10 pm to 3 mm, and the width of the second recess and the width of the first recess are 12 μm to 5 mm.

16. The artificial photosynthesis module according to claim 14,
wherein the width of the first protrusion and the width of the second protrusion are 10 μm to 3 mm, and the width of the second recess and the width of the first recess are 12 μm to 5 mm.

17. The artificial photosynthesis modules according to claim 1,
wherein the hydrogen generation electrode and the oxygen generation electrode are formed using a screen printing method, an ink jet method, or a photo-etching method.

18. The artificial photosynthesis modules according to claim 2,
wherein the hydrogen generation electrode and the oxygen generation electrode are formed using a screen printing method, an ink jet method, or a photo-etching method.

19. The artificial photosynthesis module according to claim 1,
wherein the photocatalyst layer has a co-catalyst provided on a surface thereof.

20. The artificial photosynthesis module according to claim 2,
wherein the photocatalyst layer has a co-catalyst provided on a surface thereof.
